(19) United States
(12) Patent Application Publication
(10) Pub. No.: US 2005/0127616 A1
(43) Pub. Date: Jun. 16, 2005

(54) Gasket between opposing sealing surfaces

(75) Inventors: Ullrich Dorniok, Bremen (DE); Frank Quast, Bielefeld (DE); Hartmut Schwettmann, Rahden (DE)

Correspondence Address: Attn: Norman P. Soloway;HAYES SOLOWAY P.C., 130 W. Cushing Street, Tucson, AZ, 85701, US

(73) Assignee: HARTING Electric GmbH & Co. KG

(21) Appl. No.: 10/990,217

(22) Filed: Nov. 16, 2004

(30) Foreign Application Priority Data
Dec. 11, 2003 (DE) 103 57 881.1

(51) Int. Cl. F16L 17/03

(52) U.S. Cl. 277/628

(57) ABSTRACT

The invention pertains to a flange gasket that consists of a bottom plate and a peripheral collar integrally formed thereon and is arranged between opposing sealing surfaces, namely between a housing that is provided with a flange and a mounting plate. The invention proposes to at least sectionally form pockets on the peripheral collar in order to attach the flange gasket to the flange in a captive fashion. Sealing lips are provided in openings in the flange gasket and aligned with the through-openings of the flange and the mounting plate, wherein said sealing lips initially hold the fixing screws inserted therein and seal the through-openings against environmental influences when the screws are tightened.

### TECHNICAL FIELD

The invention pertains to a gasket to be arranged between opposing sealing surfaces, particularly a flange gasket for a housing flange arranged on a housing and a correspondingly designed mounting plate.

### BACKGROUND OF THE INVENTION

When mounting a housing that is provided with a flange and contains, for example, sensible components, a flange gasket of this type is required in order to ensure a reliable seal against an external industrial atmosphere. It is widely known to secure housings that can be assembled and are provided with a flange from environmental influences by means of a gasket arranged between the flanges. However, this does not ensure that the screw connections for holding the flanges together are also sealed relative to the environment in the region of the through-openings between the screw, the gasket and the flange.

DE 37 20 224 C2 discloses a flange gasket for a pipeline, in which an U-shaped sealing lip that points into the interior of the pipeline is integrally formed onto an inner gasket ring of rubber or plastic.

### BRIEF SUMMARY OF THE INVENTION

The invention is based on the objective of realizing a flange gasket of the initially cited type in such a way that it can be attached to a flange in a captive fashion, and that the flange gasket ensures a reliable seal on a fixing screw that is arranged in a through-opening and serves for mounting the flange on a mounting plate.

This objective is attained in that the flange gasket contains a bottom plate with an outer peripheral collar, onto which at least one planar structure is integrally formed such that it is situated above and spaced apart from the bottom plate, in that the integral planar structure forms at least one pocket together with the bottom surface situated underneath, in that openings that lie above one another are provided in the pocket, and in that least one of the openings contains a sealing lip.

Advantageous embodiments of the invention are disclosed in claims 2-9.

The main advantage attained with the invention is that a flange gasket of this type can be attached, for example, to a rectangular flange in a captive fashion, wherein pocket-shaped structures formed in the corner regions of the flange gasket protrude over the corner regions of the flange. This simplifies the handling during the installation, and the flange gasket is also held on the flange during the disassembly. The pocket-shaped structures contain openings that are aligned with the through-openings of the flange or a housing to be mounted, respectively. Fixing screws are then inserted into these openings, and said fixing screws are advantageously held in the region of the openings due to their relatively small diameter in comparison with the diameter of the fixing screws. In this case, the opening of the flange gasket that lies on the flange contains a peripheral bead-like elevation that is directed toward the screw head and a funnel-shaped opening that extends over the material thickness of the flange gasket.

A sealing lip is provided in the outlet region of the funnel, wherein the design of the sealing lip may differ in dependence on the aperture angle of the funnel that may lie between a relatively obtuse angle and a relatively flat angle. When a flat angle is chosen, the sealing lip is designed with a very thin outlet such that the material is able to a very tightly adjoin the bolt of the screw. In this respect, the inside diameter of the sealing lip should always be smaller than the diameter of the fixing screw in order to achieve a more or less tight contact. Consequently, a very tight seal of the flange including the openings for the fixing screws can be achieved depending on the respective application. It is also advantageous to provide a web at least on the longitudinal side of the flange gasket, wherein said web extends along the flange to be mounted and thusly reinforces and holds the flange gasket in an optimal position. Since the flange gasket consists of a moulded part, no waste products are accumulated during its manufacture.

### BRIEF DESCRIPTION OF THE DRAWINGS

One embodiment of the invention is illustrated in the figures and described in greater detail below. The figures show:

FIG. 1, a plug-type connector housing with a flange gasket;

FIG. 2a, a perspective representation of a flange gasket with four individual pockets;

FIG. 2b, a perspective representation of a flange gasket with a peripheral pocket;

FIG. 2c, a perspective representation of a flange gasket with two pockets on the narrow sides;

FIG. 3a, an enlarged detail of a sealing lip of the flange gasket;

FIG. 3b, a variation of the sealing lip;

FIG. 3c, another variation of the sealing lip, and

FIG. 4, an enlarged sectional representation of an installed flange gasket.

### DETAILED DESCRIPTION OF THE PREFERRED EMBODIMENT

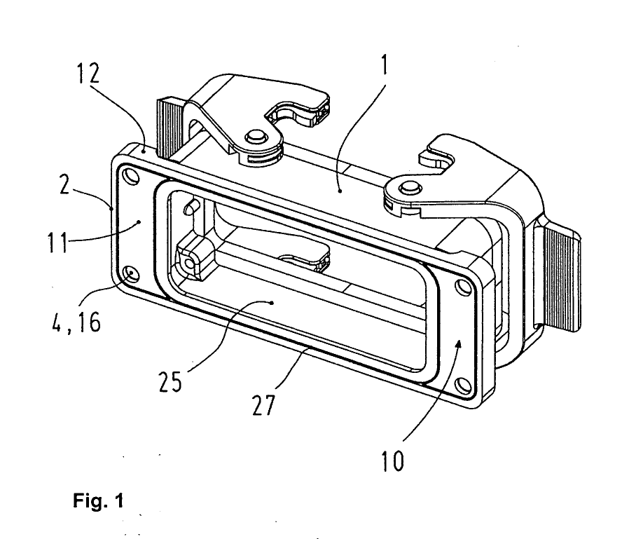

FIG. 1 shows a perspective representation of a plug-type connector housing 1 with a peripheral housing flange 2, to which a flange gasket 10 according to the invention is attached in a captive fashion. The flange gasket contains a bottom plate 11 with a perpendicular collar 12 integrally formed thereon, as well as openings 16 that are aligned with the through-openings 4 in the corner regions of the housing flange. The bottom surface 11 contains sealing webs 27 that not only serve for stabilizing the flange gasket, but also for sealing the outer region relative to the inner region with the opening 25.

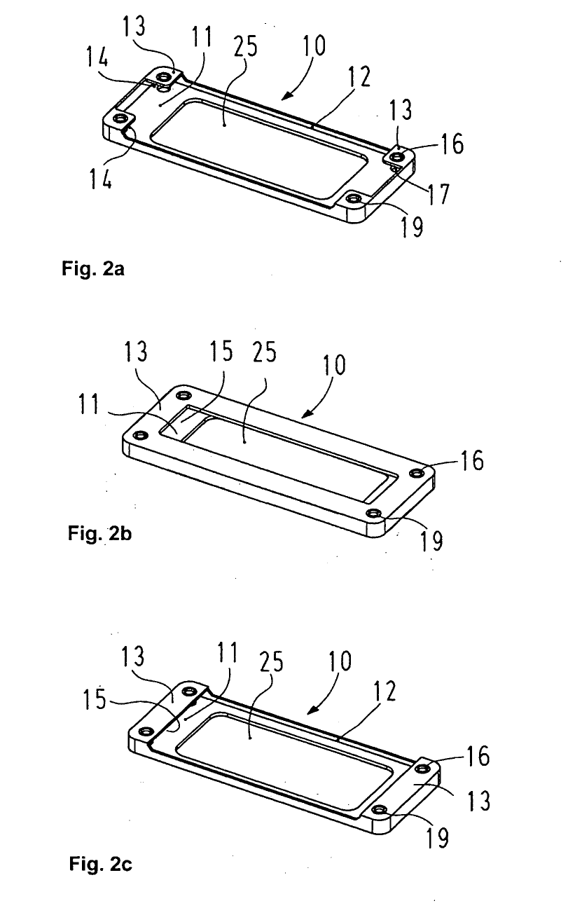

FIGS. 2a-c show perspective representations of different variations of the flange gasket 10. The flange gasket 10 according to FIG. 2a consists of a flat bottom plate 11 that is manufactured from an elastic material and contains a cutout 25, as well as a perpendicular collar 12 that is integrally formed onto the bottom plate and provided with integral planar structures 13 in the corner regions. The integral planar structures are spaced apart from and arranged above the bottom plate, wherein the planar structures respectively form one pocket 14 in the corner regions of the flange gasket together with the bottom plate. The pockets 14 contain openings 16, 17 that are aligned with the through-openings 4 in the housing flange 2.

The figure also shows a bead-like elevation 19 that peripherally extends around the upper opening 16 and is described further below. The flange gasket can be attached in a captive fashion to a correspondingly designed housing flange 2 by means of these pockets.

FIG. 2b shows a variation of the flange gasket, in which an integral planar structure 13 extends peripherally around the gasket such that a peripheral pocket 15 is formed and the housing flange is completely surrounded by and covered with a flange gasket of this type.

FIG. 2c shows another variation of the flange gasket, in which a continuous planar structure 13 is integrally formed onto both narrow sides, wherein the integral planar structures form a corresponding pocket 15 with an opening 16 for attaching the gasket to a corresponding housing flange.

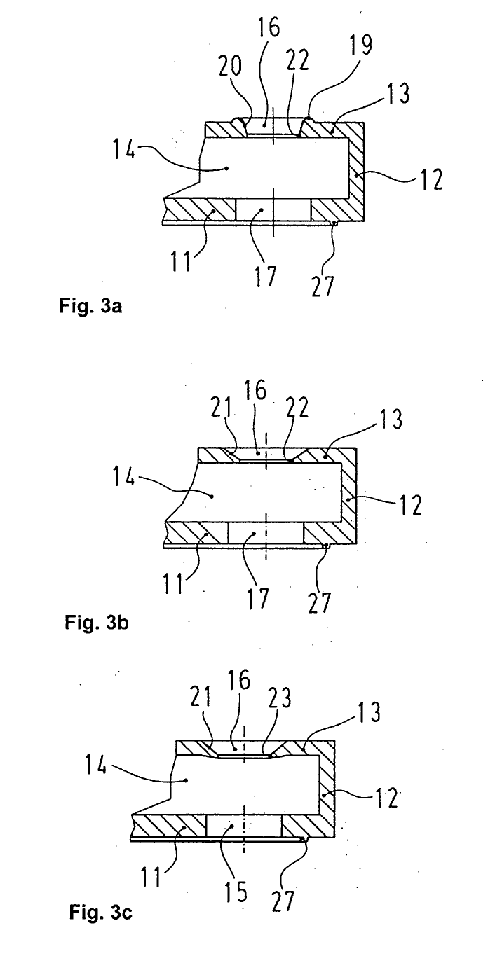

FIGS. 3a-c respectively show enlarged sectional representations of differently designed pockets 14 in the corner regions of the flange gasket 10. These figures show the axially aligned openings 16, 17 that lie on top of one another, wherein the lower opening 17 has a larger diameter than the upper opening. The upper opening 16 is realized in such a way that a peripheral elevation 19 is formed, wherein a tapered funnel 20 extends downward to a sealing lip 22 from said peripheral elevation. The invention proposes that the inside diameter of the sealing lip 22 is smaller than the bolt diameter 32 of a fixing screw 30 for mounting the flange gasket, for example, on a mounting plate 7. The tapered shape of the sealing lip 22 initially causes the fixing screw 30 to be held therein in a captive fashion.

FIG. 3b shows a variation of a sealing lip 22 according to FIG. 3a, in which the funnel 21 has a significantly flatter angle.

FIG. 3c also shows a variation, in which the funnel 21 is realized with a flat angle, wherein the sealing lip 23 is arranged, however, underneath the level of the lower material boundary of the integral planar structure 13.

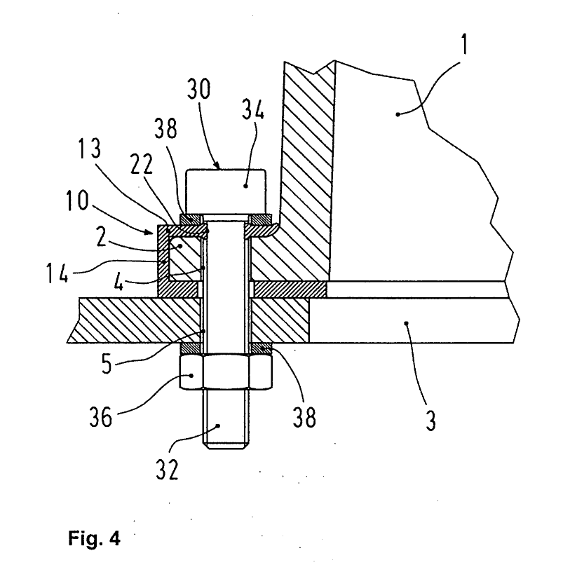

FIG. 4 shows a highly enlarged detail of a flange gasket 10 that is installed between the plug-type housing 1 and the mounting plate 7, wherein the pocket 14 encompasses the housing flange 2. The fixing screw 30 was already inserted into the through-opening 4 of the housing flange 2 during the preassembly, wherein the screw is held in a captive fashion by the sealing lip 22. During the initial mounting of the plug-type housing 1 on the mounting plate 7, the sealing lip 22 according to FIG. 3a that is directed toward the screw bolt 32 tightly adjoins the screw bolt when the fixing screw 30 is inserted, namely because the sealing lip has a smaller diameter than the fixing screw. Subsequently, the fixing screw is inserted into the through-opening 5 in the mounting plate 7 and tightened with the aid of the washer 38 and the lock nut 36. The part of the integral planar structure 13 of the flange gasket that lies on the housing flange 2 is provided with a bead-like peripheral elevation 19 that is directed toward the upper washer 38 and increasingly compressed between the washer 38 and the contact surface between the flange and the screw bolt when the screw connection is tightened. The sealing lip 22 is simultaneously pressed against the screw bolt and the flange gasket becomes increasingly tighter toward the through-opening. Consequently, it is ensured that no environmental influences can penetrate into the interior of the housing 7 via the through-openings 4, wherein a degree of protection in excess of IP 65 is achieved.

1. A gasket to be arranged between opposing sealing surfaces, particularly a flange gasket for a housing flange arranged on a housing and a correspondingly designed mounting plate, wherein the flange gasket contains a bottom plate with an outer peripheral collar, onto which at least one planar structure is integrally formed such that it is situated above and spaced apart from the bottom plate, the integral planar structure forms at least one pocket together with the bottom surface situated underneath, in that openings that lie above one another are provided in the pocket, and at least one of the openings contains a sealing lip.

2. The flange gasket according to claim 1, wherein the openings in the pocket are aligned with the through-openings of the housing flange and the mounting plate.

3. The flange gasket according to claim 1 wherein at least the opening contains a bead-like elevation that peripherally extends on the integral planar structure.

4. The flange gasket according to claim 1, wherein the opening has the shape of a funnel.

5. The flange gasket according to claim 1, wherein the opening contains differently shaped sealing lips.

6. The flange gasket according to claim 1, wherein the diameter of the opening with the sealing lip is smaller than the diameter of the opening, and in that the diameter of the sealing lip is smaller than the bolt diameter of a fixing screw.

7. The flange gasket according to claim 1, wherein the pocket at least sectionally encompasses the housing flange.

8. The flange gasket according to claim 1, wherein a pocket is provided that peripherally encompasses the housing flange.

9. The flange gasket according to claim 1, wherein the sealing surface of the bottom plate that points to the mounting plate is provided with at least one peripheral web.
